(19) United States
(12) Patent Application Publication
(10) Pub. No.: US 2024/0404032 A1
(43) Pub. Date: Dec. 5, 2024

(54) METHOD FOR IDENTIFYING AND CHARACTERIZING, BY MEANS OF ARTIFICIAL INTELLIGENCE, SURFACE DEFECTS ON AN OBJECT AND CRACKS ON BRAKES DISCS SUBJECTED TO FATIGUE TESTS

(71) Applicant: Brembo S.p.A., Curno, Bergamo (IT)

(72) Inventors: Stefano BELOTTI, Curno, Bergamo (IT); Danilo BENETTI, Curno, Bergamo (IT); Micael RESCATI, Curno, Bergamo (IT)

(21) Appl. No.: 18/696,384

(22) PCT Filed: Sep. 28, 2022
(86) PCT No.: PCT/IB2022/059237

§ 371 Date: Mar. 28, 2024

(30) Foreign Application Priority Data
Sep. 30, 2021 (IT) 102021000025085

(51) Int. Cl. G06T 7/00; G01N 21/88; G06T 5/80; G06T 7/62; G06T 7/73; G06T 7/80; G06V 10/774; G06V 10/776; G06V 10/82; G06V 20/50; G06V 20/70

(52) U.S. Cl. CPC G06T 7/0002; G01N 21/8851; G06T 5/80; G06T 7/62; G06T 7/73; G06T 7/80; G06V 10/774; G06V 10/776; G06V 10/82; G06V 20/50; G06V 20/70; G01N 2021/8887; G06T 2207/10016; G06T 2207/20081; G06T 2207/20084

(57) ABSTRACT

A method for identifying and characterizing surface defects on an object is described. Such a method comprises the steps of acquiring at least one digital image of the object or a part of the object on which the surface defects must be identified; then, providing the aforesaid at least one acquired digital image to an algorithm trained by means of artificial intelligence and/or machine learning techniques; then, identifying one or more surface defects present in the at least one acquired digital image, by means of said trained algorithm, and generating digital information related to each identified surface defect. The method then provides determining, for each identified surface defect, at least one respective dimensional parameter, representative of at least one dimension of the surface defect, and at least one respective positional parameter, representative of a position of the surface defect with respect to a reference point or line present in the image or to a two-dimensional spatial coordinate system associated with the aforesaid reference point or line. The aforesaid determining step is performed through a further processing of the aforesaid digital information, by electronic processing means. A method for identifying and characterizing cracks on a brake disc is also described.

### TECHNOLOGICAL BACKGROUND OF THE INVENTION

### Field of Application

The present invention relates to a method for identifying and characterizing surface defects on an object by means of artificial intelligence (AI).

More in particular, the present invention further relates to a method based on artificial intelligence (AI) for identifying and characterizing cracks on a brake disc.

### DESCRIPTION OF THE PRIOR ART

The use of artificial intelligence (AI) and Computer Vision (CV) techniques for detecting surface defects or cracks and the quantification thereof in dimensional terms is now well-established. Such tools include the analysis, by an appropriately designed algorithm (usually one or more neural networks), of images taken by an operator or by a robot in which surface defects of different sizes and severity can be present. The main application areas are related to monitoring industrial, civil infrastructures and/or products operating in harsh environments (e.g., nuclear reactors, underwater structures, etc.).

Before the appearance of these methods, the images were reviewed by a human operator. However, this procedure is very costly in terms of resources. Therefore, given the availability of images, it is immediate to conceive using well-established artificial intelligence or computer vision techniques applied to the detection of objects in images to automate this process.

However, for a large-scale application of such techniques, several problems remain unresolved, or in any case some needs have not been fully met.

Firstly, the need is felt to identify the position of the surface defects not only with respect to absolute spatial reference systems, but also with respect to spatial reference systems coupled to relevant parts of the object to be examined and present in the image to be analyzed.

Secondly, for many applications, there is also a need not only to identify but also to monitor the appearance and evolution of surface defects in dynamic contexts, for example in mechanical components in dynamic operation or subjected to dynamic or fatigue tests.

The aforesaid requirements are not satisfactorily met in the known solutions.

An important and paradigmatic application example is the need to identify and monitor cracks on brake discs.

In the prior art, no attempt has been made to exploit the potential of artificial intelligence, or of machine learning (ML) techniques or algorithms for the identification of cracks on brake discs.

According to the procedures currently in use, in order to measure the resistance of a braking system to thermal-mechanical stresses, it is tested on a dynamometric test bench, in which a predetermined braking sequence is applied in terms of operating parameters (rotation speed, braking pressure/torque, temperature). The test protocol provides for the bench to be stopped at predetermined time intervals and the stationary disc to be visually inspected by an operator.

If cracks are identified on both sides of the disc braking surface, the length related to the longest of each side is measured by means of a caliper and recorded. The test is interrupted as soon as, during a stop, the operator detects a crack which exceeds a certain threshold length expressed in terms of fraction of the radial extension of the braking surface or a crack excessively close to the outer or inner edge of the surface.

The fatigue tests thus conducted are very expensive from the point of view of resources, also due to the long duration thereof (some particularly long tests are in the order of weeks of test). In fact, in addition to the prolonged occupation of a machine, it is necessary to ensure the constant presence of an operator, who takes care of the manual measurement of the cracks in the stop times prescribed by the protocol. Furthermore, the periodic stop is a further cause of cost: in fact, it is necessary to periodically stop the bench and wait until the disc has cooled down, to allow the operator to access it.

Furthermore, the measurements performed by the operators are not always reliable or accurate, thus introducing a further error factor in the behavioral analysis of the tested component.

Finally, this method of conducting the fatigue tests does not allow all the available information to be extracted from the experiment. In fact, in addition to the periodic information on the length of the longest crack present on the braking surface, it would be interesting to know the length, radial position and angular location for all the identified cracks on the disc. Furthermore, it would be interesting to collect data on the evolution over time of these quantities, as well as the number of cracks present. The availability of these data would allow a better study of the behavior of the tested product.

### SUMMARY OF THE INVENTION

It is an object of the present invention to provide a method for identifying and characterizing, by means of the use of artificial intelligence, surface defects on an object, which allows at least partially obviating the drawbacks mentioned above with reference to the prior art, and responding to the aforementioned needs particularly felt in the technical field considered.

Such an object is achieved by a method according to claim 1.

Further embodiments of such a method are defined in claims 2-13 and 27.

A further object of the invention is to provide a method for identifying and characterizing cracks on a brake disc, by means of the use of artificial intelligence. Such an object is achieved by a method according to claim 14.

Further embodiments of such a method are defined in claims 15-26.

In relation to such an object, another goal of the present invention is to exploit the potential of AI, combined with classical CV techniques, so as to automate the fatigue tests of brake discs. More in detail, it is a question of automating the identification and quantification of the cracks occurring on the braking surface during a test, so as to make the experiment more efficient from the point of view of the resources used and to maximize the amount of information extracted. Furthermore, the automation of the process meets the need to make the results obtained more reliable, repeatable and objective.

Other objects of the invention are to provide methods for performing fatigue tests on a mechanical component, and in particular on a brake disc (employing the aforesaid methods of identifying and characterizing surface defects and cracks). Such objects are achieved by methods according to claims 28 and 29, respectively.

### BRIEF DESCRIPTION OF THE DRAWINGS

Further features and advantages of the method according to the invention will become apparent from the following description of preferred exemplary embodiments, given by way of non-limiting indication, with reference to the accompanying drawings, in which:

FIG. 1 is a block diagram showing an embodiment of the method according to the invention;

FIG. 2 depicts experimental arrangements for performing fatigue tests on a brake disc, to which the execution of the method according to the invention can be associated;

FIG. 3 is a simplified block diagram showing some steps comprised in an embodiment of the method;

FIG. 4 shows a brake disc in which known cracks are labeled, in accordance with a step of the method according to an embodiment of the invention;

FIG. 5 shows an example image which is provided as input to a machine learning algorithm, during a training step, according to an embodiment of the method of the invention;

FIG. 6 shows an example of an image which is obtained in output from the machine learning algorithm, according to an embodiment of the method of the invention;

FIG. 7 shows geometric parameters and an optical diagram of a pin-hole camera, employed in an embodiment of the method of the invention;

FIG. 8 shows an exemplary arrangement of a portion of the brake disc which allows a reference coordinate system to be associated with the image of the brake disc;

FIG. 9 depicts a precision-recall diagram;

FIG. 10 shows a simplified block diagram of a system capable of carrying out the method according to the invention.

### DETAILED DESCRIPTION

A method for identifying and characterizing surface defects on an object is described.

Such a method comprises the steps of acquiring at least one digital image of the object or a part of the object on which the surface defects must be identified; then, providing the aforesaid at least one acquired digital image to an algorithm trained by means of artificial intelligence and/or machine learning techniques; then, identifying one or more surface defects present in the at least one acquired digital image, by means of said trained algorithm, and generating digital information related to each identified surface defect.

The method then provides, for each identified surface defect, determining at least one respective dimensional parameter, representative of at least one dimension of the surface defect, and at least one respective positional parameter, representative of a position of the surface defect with respect to a reference point or line present in the image or to a two-dimensional spatial coordinate system associated with the aforesaid reference point or line.

The aforesaid determining step is performed through a further processing of the aforesaid digital information, by electronic processing means.

In accordance with an embodiment, the method is configured to identify and characterize surface defects on a mechanical component under dynamic conditions.

In such a case, the aforesaid step of acquiring comprises acquiring a plurality of digital images of the mechanical component, in sequence, acquired during a dynamic evolution of the operation of the mechanical component.

The aforesaid steps of providing, identifying, generating and determining are carried out continuously, in sequence, on the digital images acquired in sequence, in order to monitor the dynamic evolution of the presence, dimensions and position of the surface defects.

According to an implementation option, the aforesaid dynamic conditions comprise a fatigue test of the mechanical component.

In such a case, the method comprises the further steps of establishing surface defect evaluation criteria for deciding whether to continue or stop said fatigue test; furthermore, continuously comparing the information related to the temporal evolution of the surface defects with the aforesaid established evaluation criteria; then, proceeding with the fatigue test, if all the criteria for assessing the surface defects are met, and instead stopping the fatigue test if at least one of the evaluation criteria is not met.

In accordance with an embodiment of the method, the aforesaid trained algorithm is an algorithm trained by means of a preliminary training step, based on a training dataset comprising digital training images, which are supplied as input to the algorithm to be trained, representing objects of the same type as the objects on which the surface defects must be identified and characterized; such objects have surface defects whose respective size parameter and respective positional parameter are known, which are also provided as input to the algorithm to be trained.

According to an implementation option of the aforesaid embodiment, the aforesaid preliminary training step operates starting from a pre-trained algorithm on the basis of a pre-training dataset different than the aforesaid training dataset, by applying transfer learning techniques, in order to arrive at the trained algorithm.

In such an implementation option, in order to build the machine learning (ML) algorithm, the transfer learning (TL) method is used, i.e., an algorithm pre-trained on another data set is chosen. Transfer learning is a technique which, in the context of machine learning, in order to solve a problem, provides applying the knowledge acquired during the resolution of a similar problem.

The re-use or transfer of information from previously learned tasks for learning new tasks has the potential to significantly improve the recognition performances of a machine learning algorithm (in particular, of a Deep Learning algorithm).

According to an implementation option of the aforesaid embodiment, the preliminary training step comprises tagging or labeling the known surface defects present in each of the digital training images; then, calibrating the parameters of the algorithm to be trained based on the digital training images processed by tagging or labeling.

According to possible implementation options, the aforesaid tagging or labeling step is carried out by highlighting the evident surface defects, on the digital training image, manually and/or with the support of facilitating software.

In accordance with an embodiment, the method comprises the further step of verifying the predictive capabilities of the trained algorithm on a further dataset of digital validation images.

According to an embodiment of the method, the aforesaid trained algorithm is a machine learning algorithm based on neural networks.

According to various implementation options, the aforesaid neural networks comprise deep neural networks, or convolutional neural networks or Region Based Convolutional Neural Networks.

According to another implementation, the aforesaid trained algorithm is a machine learning algorithm based on Deep Object Detectors or Two-stage Deep Object Detectors.

In accordance with an embodiment of the method, the aforesaid step of identifying one or more surface defects, present in the at least one acquired digital image, comprises recognizing the surface defects, by the trained algorithm, and, for each recognized surface defect, identifying the spatial coordinates of the surface defect with respect to a reference coordinate system of the acquired digital image, to which the portions of the object depicted are also referred in a known manner.

The aforesaid step of generating information related to each surface defect comprises generating, for each identified surface defect, digital information representative of the aforesaid spatial coordinates of the surface defect, and storing such digital information making it available for subsequent processing.

According to an embodiment, the aforesaid determining step comprises determining, for each surface defect, the respective dimensional parameter and positional parameter based on the spatial coordinates of the surface defect.

In accordance with an embodiment, the method comprises, before the step of acquiring, the further steps of performing a calibration of the image acquisition means, and then acquiring data, following the calibration, to compensate for geometric distortion effects in the image acquisition.

According to various possible application examples, the method is employed to detect surface defects on various possible surfaces, for example smooth, rough, spongy, or other.

In accordance with various implementations, the method is applied to identify and characterize surface defects on wood and/or plastic and/or fabric objects.

In accordance with other implementations, the method is applied to identify and characterize surface defects on objects in glassy, ceramic, cement, metallic materials.

It should be noted that the method shown above, due the features thereof, can be applied to a wide plurality of objects, also consisting of different materials with respect to those mentioned above.

It should also be noted that, in several possible application examples, the method is used to detect surface defects of various types, including cracks, holes, tears, scratches, chipping, stains.

In fact, the method shown above, for the features thereof, can be applied to a wide plurality of surface defects, which can generally be defined as any inhomogeneity which can be captured by an image with respect to a background, for example all the inhomogeneities which the human eye can manage to perceive with respect to a uniform background.

According to various implementations, the step of acquiring a digital image is carried out by already known image acquisition means, such as a camera, a video camera, or any other image acquisition device in the visible spectrum.

In a preferred embodiment, the method, performed according to any one of the embodiments shown above, is used in the field of detecting and monitoring cracks on a brake disc, and more specifically on a braking surface or element of the brake disc.

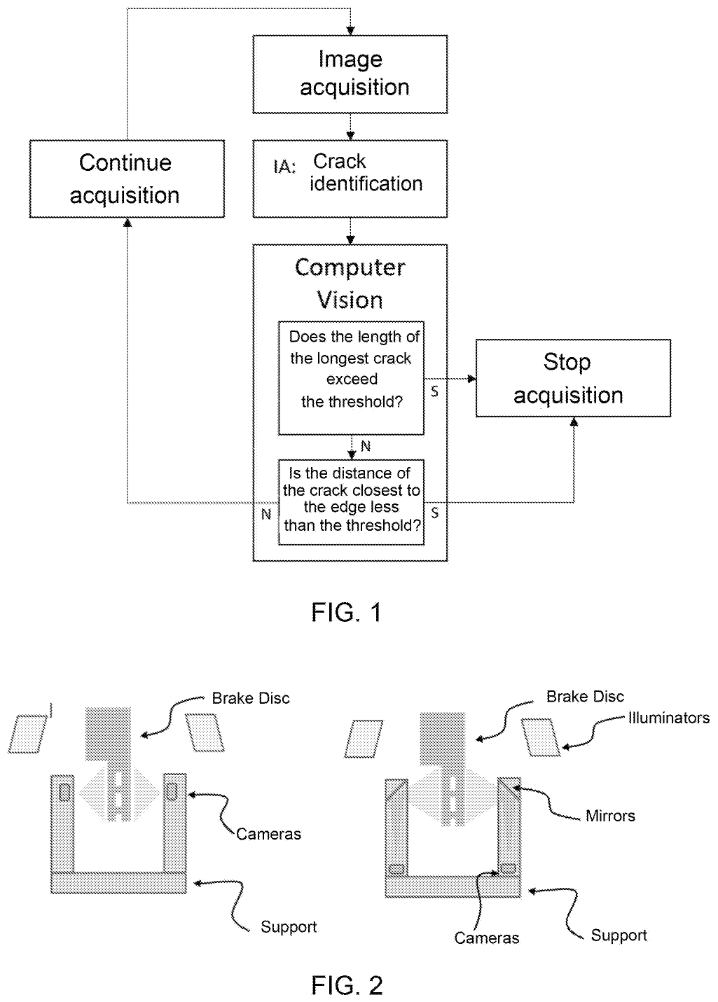

Such an embodiment is shown in more detail below, referring to FIGS. 1-11.

In accordance with such an embodiment, the method is configured to identify and characterize cracks on a braking surface or element of a brake disc. In such a case, therefore, the aforesaid object is a brake disc and the aforesaid defects are cracks of the brake disc.

In such a case, the aforesaid acquisition step comprises acquiring at least one digital image of the braking surface or element of the brake disc, in which the set of the least one digital image represents the entire annulus corresponding to the braking surface or element.

The aforesaid step of providing comprises providing the at least one acquired digital image to the algorithm trained by means of artificial intelligence and/or machine learning techniques.

The aforesaid identifying step comprises identifying one or more cracks present in the at least one acquired digital image, by means of the aforesaid trained algorithm, and generating digital information related to each identified crack.

The aforesaid dimensional parameter comprises in this case a crack length (i.e., the crack extension dimension, since the crack is a mainly one-dimensional defect).

The aforesaid positional parameter comprises the position of the crack with respect to an edge of the brake disc and/or the braking surface, so that the determining step comprises determining, through the aforesaid further processing, for each identified crack, the respective length and the respective positional parameter representative of the position of the crack with respect to an edge of the brake disc and/or the braking surface.

According to an implementation option of such an embodiment, the method is configured to identify and characterize cracks on a braking surface or element of a brake disc under dynamic conditions.

In such a case, the acquisition step comprises acquiring a plurality of digital images of the braking surface or element of the brake disc, sequentially, acquired during a dynamic evolution of the operation of the brake disc; the steps of providing, identifying, generating and determining are performed continuously, in sequence, on the sequentially acquired digital images, in order to monitor the dynamic evolution of the presence, length and position of the cracks.

According to an application example of the method, in which the aforesaid dynamic conditions comprise a brake disc fatigue test, the method comprises the further steps of establishing crack evaluation criteria for deciding whether to continue or stop the fatigue test; furthermore, continuously comparing the information related to the temporal evolution of the cracks with the established evaluation criteria; the method then comprises proceeding with the fatigue test, if all the crack evaluation criteria are met, and instead stopping the fatigue test if at least one of the evaluation criteria is not met.

According to various possible implementation options of this embodiment, the aforesaid evaluation criteria comprise one or more of the following criteria:
the length of each crack is less than a predefined maximum length, considered no longer acceptable for the continuation of the fatigue test; and/or
the ends of all the cracks are distant from the edges of the braking surface or brake disc more than a predefined minimum distance, which is no longer considered acceptable for the continuation of the fatigue test.

According to an implementation option of this embodiment, the aforesaid trained algorithm is an algorithm trained by means of a preliminary training step, based on a training dataset comprising digital images of braking surfaces with known cracks, supplied as input to the algorithm to be trained, along with input information related to known crack sizes and locations.

With reference to the machine learning or artificial intelligence algorithms, used in the method to identify and characterize cracks on the brake disc, all the implementation options, already shown above with reference to the more general method of identifying and characterizing surface defects, can be used.

According to an implementation option, already previously mentioned, of the aforesaid embodiment, the aforesaid preliminary training step operates starting from a pre-trained algorithm on the basis of a pre-training dataset different than the aforesaid training dataset, by applying transfer learning techniques in order to arrive at the trained algorithm.

In other words, in order to build the machine learning (ML) algorithm, the transfer learning (TL) method is used, i.e., an algorithm pre-trained on another data set is chosen. Transfer learning is a technique which, in the context of machine learning, in order to solve a problem, provides applying the knowledge acquired during the resolution of a similar problem.

According to a particular implementation example that has been experimented, the crack recognition algorithm was created by means of transfer learning, training a Mask-RCNN algorithm on a vast dataset (more than 200,000 samples) of images and annotations of common objects (e.g., cars, people, aircraft) in the related context, which was then taught, through a more specific training process, to recognize cracks on the brake disc.

The application of the aforesaid transfer learning technique (with respect to a conventional Deep Learning algorithm training to recognize cracks, starting “from scratch”), allows, with the same number of images used in the training, to reach much better algorithm performance.

According to an implementation option, the aforesaid preliminary training step comprises tagging or labeling the known cracks present in each of the digital training images; then, calibrating the parameters of the algorithm to be trained based on the digital training images processed by tagging or labeling.

In accordance with an implementation example, the aforesaid tagging or labeling step is carried out by drawing a line, on the digital training image, which traces the spatial trend of each evident crack, manually and/or with the support of facilitating software.

According to an implementation, the “labelMe” tool is used.

According to a possible operating mode, such a tool generates an “accompanying” file the information content of which specifies where the cracks are located in the image, for example by reporting a list of coordinates in pixels for all the end points of the cracks present in the image.

In accordance with an implementation option, the aforesaid step of identifying one or more cracks, present in the at least one acquired digital image, comprises recognizing the cracks, by the trained algorithm, and, for each recognized crack, identifying the spatial coordinates of the ends of the crack, approximated as a segment, with respect to a reference coordinate system of the acquired digital image, to which the depicted parts of the brake disc or braking surface are also referred in a known manner.

In such a case, the aforesaid step of generating information related to each crack comprises generating, for each identified crack, digital information representative of the spatial coordinates of the crack, and then storing such digital information making it available for subsequent processing.

According to an implementation option, the aforesaid step of generating information further comprises generating a respective at least one processed digital image containing highlights and/or indications related to the one or more identified cracks.

In accordance with an implementation option, the aforesaid step of determining the length and at least one respective parameter representative of the crack position, for each identified crack, is carried out by means of an untrained image processing algorithm.

According to a particular implementation option, the aforesaid step of determining the length and at least one respective parameter representative of the crack position, for each identified crack, is carried out by means of an untrained computer vision (CV) algorithm.

In accordance with an implementation option, the aforesaid step of determining the length and at least one respective parameter representative of the crack position, for each identified crack, is carried out by means of a further machine learning algorithm.

According to another implementation option, the aforesaid step of determining the length and at least one respective parameter representative of the crack position, for each identified crack, is carried out by the same trained machine learning (ML) algorithm configured to carry out said step of identifying one or more cracks.

In the latter case, a single ML algorithm performs all the steps of the method, from the image to the length and/or position of the crack.

In such a case, according to an implementation variant also comprised in the invention, an end-to-end deep learning algorithm is used which directly generates the length of the cracks from the image and the position thereof with respect to a real reference system always contained in the image (for example the edge of the disc) without passing through the determination of the image coordinates.

In accordance with an implementation option, the aforesaid step of determining the length and at least one respective parameter representative of the crack position, for each identified crack, comprises the following steps:
calculating the length of a crack based on the coordinates of the respective ends;
calculating the aforesaid at least one respective parameter representative of the crack position as the distance from the edge of the end of the crack closest to the edge based on the coordinates of said end and the coordinates of the edge, with respect to the aforesaid reference system.

According to other implementation options, the aforesaid step of calculating the parameter representative of the crack position comprises calculating the radial position and angular location of the crack on the brake disc.

A method for performing a fatigue test on a mechanical component is now described.

Such a method comprises performing, during the performance of the fatigue test, a method for identifying and characterizing surface defects according to any one of the embodiments previously described.

Such a method thus includes proceeding with the fatigue test if all the crack evaluation criteria of a predefined set of evaluation criteria are met; and instead stopping the fatigue test if at least one of the evaluation criteria is not met.

A method for performing a fatigue test on a brake disc is now described.

Such a method comprises performing, during the performance of the fatigue test, a method for identifying and characterizing cracks on a brake disc according to any one of the embodiments previously described.

Such a method then provides proceeding with the fatigue test if all the crack evaluation criteria of a predefined set of evaluation criteria are met; and instead stopping the fatigue test if at least one of the evaluation criteria is not met.

The aforesaid predefined evaluation criteria comprise, for example:
the length of each crack is less than a predefined maximum length, considered no longer acceptable for the continuation of the fatigue test; and/or
the ends of all the cracks are distant from the edges of the braking surface or brake disc more than a predefined minimum distance, which is no longer considered acceptable for the continuation of the fatigue test.

Further details of the method, merely by way of non-limiting example, according to a particular embodiment of the invention, focused on a method for identifying and characterizing cracks on the surface of a brake disc subjected to fatigue testing, will be reported below, with reference to FIGS. 1-10.

The logical flow of such a method is depicted in FIG. 1.

Before the start of the fatigue test on the dynamometric bench, an experimental apparatus is mounted on the dynamometric bench which is capable of periodically acquiring still images of different portions of the braking surface for the entire duration of the test. In this example, the portions of disc photographed are such that it is possible to periodically obtain information related to the entire annulus of the braking surface for the entire duration of the test.

According to an implementation option, the acquisition is done simultaneously on both sides of the disc.

In an implementation option, the aforesaid system, or experimental apparatus, mounted on the test bench consists of two metal supports each of which include a camera appropriately chosen to have a size compatible with the dimensions of the bench braking system and as broad a range of operating temperature as possible. The arms are mounted at a preset distance from the surface of the disc, so as to keep the frame in focus (see FIG. 2). The optical axis of each camera is required to reach the disc in a perpendicular orientation with respect to the surface thereof.

According to an implementation option, the dynamic bench software is entirely responsible for managing the image acquisition system, which manages and acquires the angular position of the brake disc, the lighting, the shooting times and saving the acquired images. At the end of the image acquisition, the bench puts itself in a pause state, waiting for the result of the image processing.

The images thus acquired represent the input for the machine learning (ML) model or algorithm capable of identifying the possible presence of cracks thereon.

According to an implementation option, the transfer learning method was used to build the ML algorithm, i.e., a pre-trained algorithm on another data set was chosen.

In the example shown here, the Mask-RCNN model was chosen, based on neural networks (NN), trained on the COCO open source dataset.

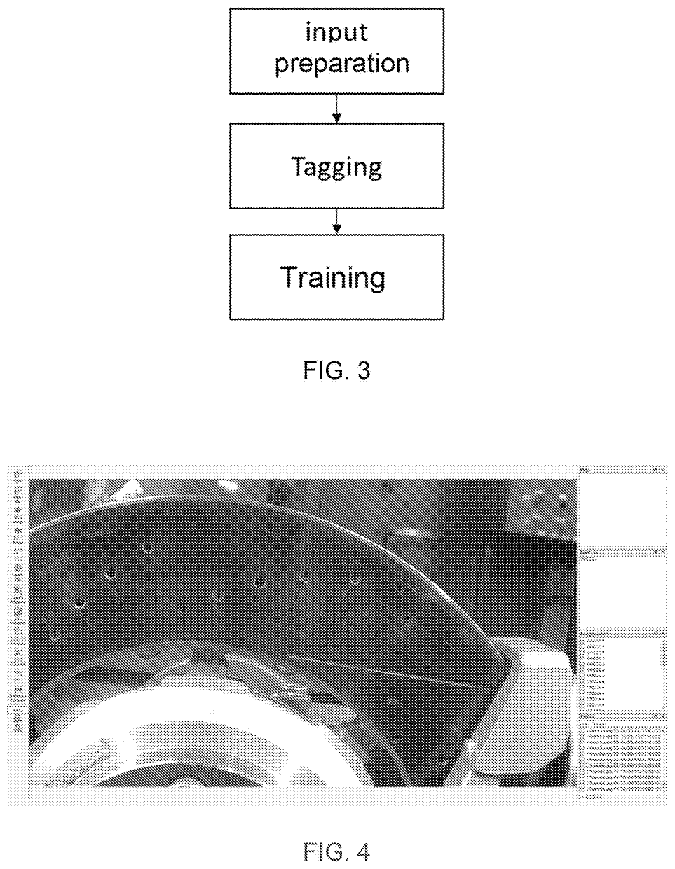

Normally, the development flow of an ML algorithm is as follows: input preparation, tagging, and model training (see FIG. 3).

Regarding the input preparation step, it is not performed since the used algorithm takes the images directly acquired by the camera at the bench as input. This is advantageous from the viewpoint of computational burden and thus also of time, which is an important factor since the algorithm is designed to work online with respect to the bench.

As regards the tagging activity, it involves the manual labelling of the cracks depicted in the images captured on the bench during the tests. In particular, the operation consists of drawing a line on the image, which traces the spatial trend of each evident crack. In the rare cases in which the crack is similar to a broken line, it is still tagged as a segment which joins the end points thereof.

Accurate tagging is a prerequisite for a well-functioning deep learning algorithm.

In accordance with an implementation option comprised in the present invention, the tool used to support the tagging activity is obtained from an open source tool (labelMe). An example of an image tagged with labelMe is shown in FIG. 4.

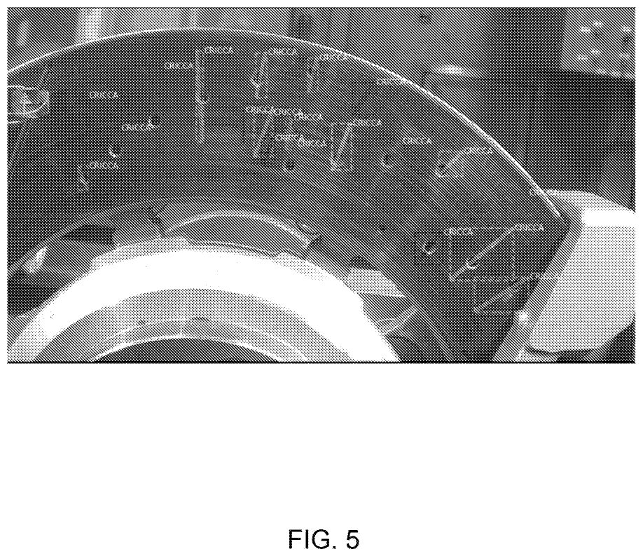

The tagging step is followed by a conventional training process: a subset of the tagged dataset (consisting of 101 image files) is provided as input to the AI algorithm to calibrate the model parameters and make it adapted to provide predictions. An example of tagged input used for model training is shown in FIG. 5.

According to a particular implementation option, the aforesaid subset of the tagged dataset is enriched by data augmentation techniques.

Once the algorithm has been trained, the predictive capabilities thereof are verified on another dataset of the same nature.

When the algorithm detects a crack on the input image with a certainty which exceeds a certain prefixed threshold, the geometric coordinates of the start and end points thereof are saved.

According to an implementation option, the reference system is that of the image.

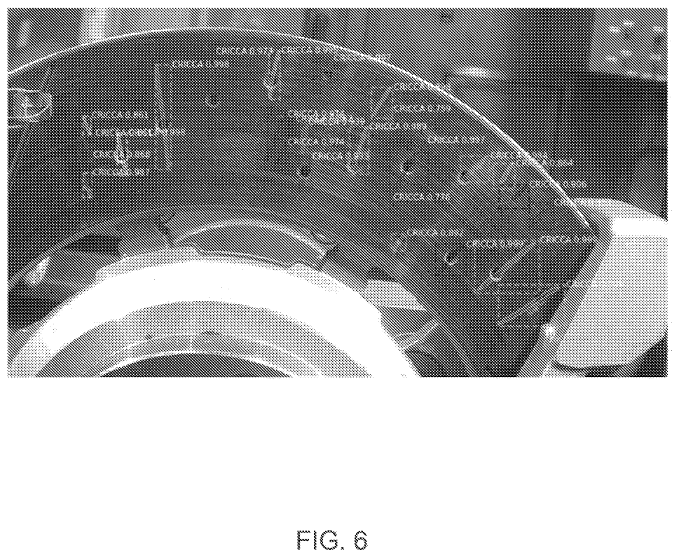

The cracks are considered segments, an approximation valid in almost all cases. This data can be displayed in graphic form on the starting image (see FIG. 6).

The next step of the method includes applying classical CV techniques to process the information related to each identified crack and calculate the length thereof reliably and without geometric distortions. In fact, each image acquired through a camera has a certain degree of distortion, as a function of how the instrument has been calibrated. This means that lengths of equal value on the acquired image do not necessarily correspond to equal lengths in reality.

In the present invention, it is also provided that the camera is calibrated once during the preparation of the experimental setup using physical references. The calibration allows the intrinsic distortion parameters of the camera to be calculated. Starting from these, it is possible to correct the phenomenon by using consolidated tools, such as the application of the matrix camera. After this processing, the distances measured on the image will be proportional to the real ones according to a constant factor.

Once the distortion possibly present has been corrected, it is possible to determine, in arbitrary units, the length of each crack in the image from the coordinates of the end points thereof. The formula is that for calculating a segment in the Euclidean plane. Comparing the result of the length calculation among all the cracks identified on the image, it is possible to determine the longest crack therein.

Extending the comparison to all the cracks present on the two braking surfaces of the disc, photographed in several images acquired within a sufficiently short period of time, it is possible to determine which crack is the longest.

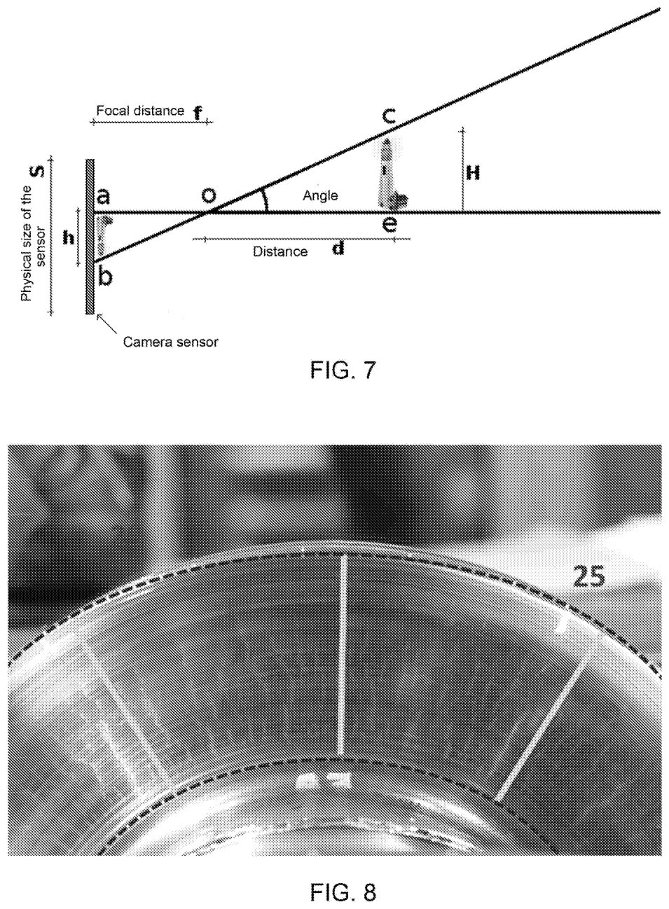

The conversion of the crack length value from arbitrary units to mm can be easily carried out by applying a pin-hole camera model (model shown in FIG. 7).

With reference to FIG. 7, the relationship between the different image acquisition parameters is therefore:

$$H = ( d / f ) ( S / R ) n$$

where H (mm) is the length of the identified pattern (e.g., crack length) represented by n pixels in an image, d (mm) is the working distance (camera-object distance), f (mm) is the focal length of the camera, S (mm) is the size of the camera sensor, and R (pixel) is the resolution of the camera sensor.

If the length of the longest crack, identified as described above, exceeds a threshold value declared by the operator and made available to the algorithm before the start of the test, it is automatically suspended.

The second criterion based on which the continuation or not of a test is decided is the respect of a minimum safety distance between cracks and the outer edge of the braking surface. Therefore, an outer band on the braking surface exists where the appearance of at least one crack, even if not entirely comprised in the area, results in the suspension of the test.

This involves knowing, for each angular position of the braking surface comprised in the camera frame, the position of the outer edge, which will be described by the equation of an ellipse.

To determine such an equation, proceed as follows. Before the start of the test, on a portion of the band entirely comprised in the frame, 3 rays on the annulus are traced with a marker in a color which stands out against the background (see FIG. 8). The coordinates of the three points of intersection between such rays and the outer perimeter of the annulus allow the desired equation to be calculated. It undergoes the same corrective mathematical transformations as the coordinates of the ends of the cracks.

From the transformed equation, it is possible to determine the position of the outer perimeter of the braking surface portion framed at any desired angular value.

If the outer end of at least one crack is located at a distance from the edge which is less with respect to a threshold value (which can be expressed in pixels or mm), the test is suspended.

From the start of the fatigue test, the algorithm is performed periodically and examines all the images necessary to cover the two sides of the braking surface of the tested disc. If at least one of the criteria which triggers the test stop is met, it is automatically suspended and a notification is sent to the operator.

By virtue of the method described in this disclosure, it is possible to periodically collect numerous information during a fatigue test related to the developing cracks: number at a certain time instant, length of each crack, position with respect to the outer edge. From such a dataset, it is possible to reconstruct the temporal evolution of the mechanical reaction of the product to the phenomenon of fatigue.

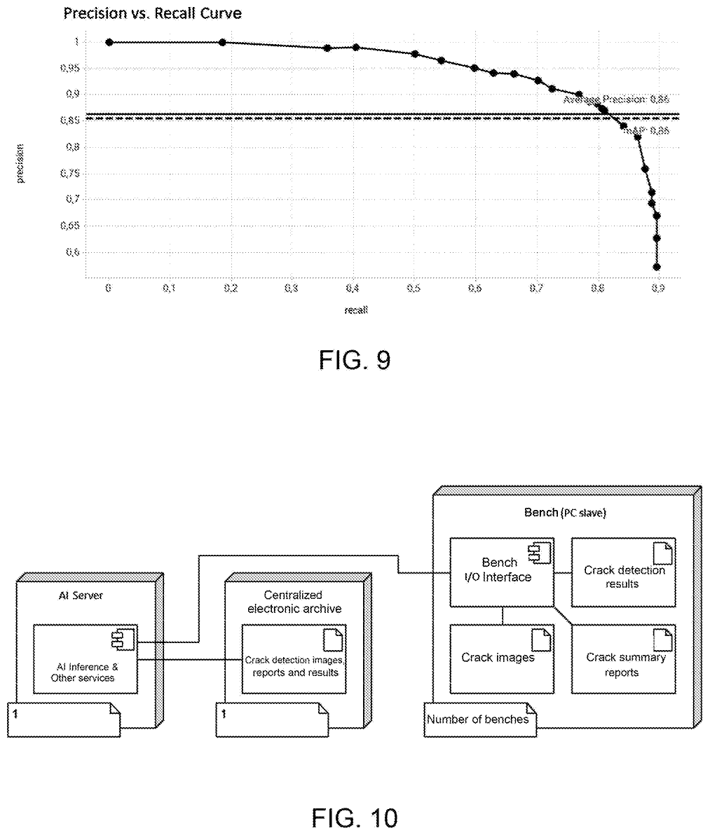

From the viewpoint of performance, the precision of the algorithm as a function of a recall variable is shown in FIG. 9.

The metrics depicted concern the performance of the model on the test dataset, i.e., on the subset of data not used to train the AI model, setting an IoU (intersection on union) parameter equal to 0.5.

In the literature, “precision” means how many true positives (i.e., how many cracks identified by the model are actually cracks) are present with respect to the total true positives plus false positives (cracks erroneously identified as such by the model).

The “recall” variable, instead, quantifies the true positives on the total of true positives plus false negatives (i.e., those cracks actually present which have not been tagged as such by the model). The model's mean Average Precision (mAP) was 0.85.

An embodiment of a system capable of implementing the methods described above, according to the invention, is shown in FIG. 10, which shows the components of the system and the connections therebetween.

The components of the system shown in FIG. 10 are:
an AI server (made using one or more electronic processors or computers), containing one or more software modules capable of implementing the AI model used, or the machine learning algorithm used (“AI inference” block) and possibly capable of implementing further services;
a centralized electronic archive, in which many saved data, deriving from the execution of the method, are stored and are present, for example images of cracks, results of crack detection, summary reports on the cracks present;
at least one experimental bench, comprising, in addition to the bench I/O interface, at least one electronic processor or computer (it is a slave computer, in the example architecture shown in FIG. 10), capable of receiving, processing and providing digital data such as images of cracks, crack detection results, summary reports on the cracks present.

According to an implementation option, the at least one electronic processor or computer present in the experimental bench is configured to perform (by means of one or more specific elements) the steps of determining at least one dimensional parameter and at least one respective positional parameter, by implementing an algorithm (even untrained) developed for this purpose, for example a computer vision (CV) algorithm, which in turn is executed by means of at least one software module loaded and executable in the computer itself.

According to the previously described implementation option (and shown in FIG. 10), the method is then implemented through the synergistic cooperation of two algorithms: an algorithm trained by means of AI or ML techniques (for crack recognition) and loaded/executable in a server computer; another untrained computer vision algorithm (for the dimension and position characterization of the identified cracks) and loaded/executable in a computer of the experimental bench.

Obviously, the two computers are operatively connected to each other.

In accordance with another implementation option, both the recognition and the characterization of the cracks are carried out by a single computer, for example the control computer of the experimental bench (embedded solution), in which the software modules implementing both the ML algorithm and the CV algorithm are present and executable.

According to another implementation option, the functions of the method are carried out by a system implemented in the cloud and/or with a serverless architecture.

As can be seen, the objects of the present invention as previously indicated are fully achieved by the method described above by virtue of the features disclosed above in detail. The advantages and technical problems solved by the method according to the invention have already been mentioned above, with reference to the various features and aspects of the method.

A person skilled in the art may make changes and adaptations to the embodiments of the methods described above or can replace elements with others which are functionally equivalent to satisfy contingent needs without departing from the scope of protection of the appended claims. All the features described above as belonging to one possible embodiment may be implemented independently from the other described embodiments.

1-29. (canceled)

30. A method for identifying and characterizing surface defects on an object, comprising the steps of:
acquiring at least one digital image of the object or of a part of the object on which surface defects must be identified;
providing said at least one acquired digital image to an algorithm trained by means of artificial intelligence and/or machine learning techniques;
identifying one or more surface defects present in the at least one acquired digital image, by means of said trained algorithm, and generating digital information related to each identified surface defect;
for each identified surface defect, determining at least one respective dimensional parameter, representative of at least one dimension of the surface defect, and at least one respective positional parameter, representative of a position of the surface defect with respect to a reference point or line present in the image or to a two-dimensional spatial coordinate system associated with said reference point or line, said determining step being performed through a further processing of said digital information, by electronic processing means;
wherein said trained algorithm is an algorithm trained by means of a preliminary training step, based on a training dataset comprising digital training images, which are supplied as input to the algorithm to be trained, representing objects of the same type as the objects on which the surface defects must be identified and characterized, said objects having surface defects whose respective size parameter and respective positional parameter are known, which are also provided as input to the algorithm to be trained.

31. A method according to claim 30, wherein said preliminary training step operates starting from a pre-trained algorithm on the basis of a pre-training dataset different than said training dataset, by applying transfer learning techniques, in order to arrive at the trained algorithm

32. A method according to claim 30, wherein the method is configured to identify and characterize surface defects on a mechanical component under dynamic conditions, and wherein:
said step of acquiring comprises acquiring a plurality of digital images of the mechanical component, in sequence, acquired during a dynamic evolution of the operation of the mechanical component;
said steps of providing, identifying, generating and determining are carried out continuously, in sequence, on said digital images acquired in sequence, in order to monitor the dynamic evolution of the presence, dimensions and position of the surface defects.

33. A method according to claim 32, wherein said dynamic conditions comprise a fatigue test of the mechanical component, and wherein the method comprises the further steps of:
establishing evaluation criteria for evaluating the surface defects adapted to decide whether to continue or interrupt said fatigue test;
continuously comparing the information related to the temporal evolution of the surface defects with said evaluation criteria;
if all the evaluation criteria for the surface defects are met, proceeding with the fatigue test;
stopping the fatigue test if at least one of the evaluation criteria is not met.

34. A method according to claim 33, wherein said preliminary training step comprises:
performing a “tagging” or labeling of the known surface defects present in each of the digital training images;
calibrating the parameters of the algorithm to be trained based on the digital training images processed by means of “tagging” or labeling,
wherein said tagging or labeling step is carried out by highlighting the evident surface defects, on the digital training image, manually and/or with the support of facilitating software,
and/or wherein the method comprises the further step of:
verifying the predictive capabilities of the trained algorithm on a further dataset of digital validation images.

35. A method according to claim 33, wherein said trained algorithm is a machine learning algorithm based on neural networks,
wherein said neural networks comprise deep neural networks, or convolutional neural networks or Region Based Convolutional Neural Networks,
or wherein said trained algorithm is a machine learning algorithm based on Deep Object Detectors or Two-stage Deep Object Detectors.

36. A method according to claim 30, wherein:
said step of identifying one or more surface defects, present in the at least one acquired digital image, comprises recognizing the surface defects, by the trained algorithm, and, for each recognized surface defect, identifying the spatial coordinates of the surface defect with respect to a reference coordinate system of the acquired digital image, to which the portions of the object depicted are also referred in a known manner,
said step of generating information related to each surface defect comprises generating, for each identified surface defect, digital information representative of said spatial coordinates of the surface defect, and storing said digital information making it available for subsequent processing,
wherein said determining step comprises determining, for each surface defect, said dimensional parameter and said positional parameter based on said spatial coordinates of the surface defect.

37. A method according to claim 30, comprising the further steps of:
before the step of acquiring, performing a calibration of the image acquisition means and acquiring data, following the calibration, to compensate for the effects of geometric distortion in the image acquisition.

38. A method according to claim 30, configured for identifying and characterizing cracks on a braking surface or element of a brake disc, wherein said object is a brake disc and said surface defects are cracks in the brake disc, wherein:
said step of acquiring comprises acquiring at least one digital image of the braking surface or element of the brake disc, wherein the set of said at least one digital image represents the entire annulus corresponding to the braking surface or element;
said step of providing comprises providing said at least one acquired digital image to the algorithm trained by means of artificial intelligence and/or machine learning techniques;
said identifying step comprises identifying one or more cracks present in the at least one acquired digital image, by means of said trained algorithm, and generating digital information related to each identified crack;
said size parameter comprises a length of the crack and said positional parameter comprises the position of the crack with respect to an edge of the brake disc and/or the braking surface, so that said determining step comprises determining, through said further processing, for each identified crack, the respective length and said respective positional parameter representative of the position of the crack with respect to an edge of the brake disc and/or the braking surface.

39. A method according to claim 38, wherein the method is configured to identify and characterize cracks on a braking surface or element of a brake disc under dynamic conditions, and wherein:
said step of acquiring comprises acquiring a plurality of digital images of the braking surface or element of the brake disc, in sequence, acquired during a dynamic evolution of the operation of the brake disc;
said steps of providing, identifying, generating and determining are performed continuously, in sequence, on said sequentially acquired digital images, in order to monitor the dynamic evolution of the presence, length and position of the cracks.

40. A method according to claim 39, wherein said dynamic conditions comprise a fatigue test of the brake disc, and wherein the method comprises the further steps of:
establishing evaluation criteria for evaluating the cracks adapted to decide whether to continue or interrupt said fatigue test;
continuously comparing the information related to the temporal evolution of the cracks with said evaluation criteria;
if all the evaluation criteria for the cracks are met, proceeding with the fatigue test;
stopping the fatigue test if at least one of the evaluation criteria is not met,
wherein said evaluation criteria comprise one or more of the following criteria:
the length of each crack is less than a predefined maximum length, considered no longer acceptable for the continuation of the fatigue test; and/or
the ends of all the cracks are distant from the edges of the braking surface or brake disc more than a predefined minimum distance, which is no longer considered acceptable for the continuation of the fatigue test.

41. A method according to claim 30, wherein said trained algorithm is an algorithm trained by means of a preliminary training step, based on a training dataset comprising digital images of braking surfaces with known cracks, supplied as input to the algorithm to be trained, along with input information related to known crack sizes and locations,
wherein said preliminary training step comprises:
performing a “tagging” or labeling of the known cracks present in each of the digital training images;
calibrating the parameters of the algorithm to be trained based on the digital training images processed by means of “tagging” or labeling,
wherein, preferably, said tagging or labeling step is carried out by drawing a line, on the digital training image, which traces the spatial trend of each evident crack, manually and/or with the support of facilitating software.

42. A method according to claim 38, wherein:
said step of identifying one or more cracks, present in the at least one acquired digital image, comprises recognizing the cracks, by the trained algorithm, and, for each recognized crack, identifying the spatial coordinates of the ends of the crack, approximated as a segment, with respect to a reference coordinate system of the acquired digital image, to which the depicted parts of the brake disc or braking surface are also referred in a known manner,
said step of generating information related to each crack comprises generating, for each identified crack, digital information representative of said spatial coordinates of the crack, and storing said digital information making it available for subsequent processing,
or wherein said step of generating information related to each crack comprises generating, for each identified crack, digital information representative of said spatial coordinates of the crack, and storing said digital information making it available for subsequent processing and further comprises generating a respective at least one processed digital image containing highlights and/or indications related to the one or more identified cracks.

43. A method according to claim 30, wherein said step of determining the length and at least one respective parameter representative of the crack position, for each identified crack, is carried out by means of an untrained computer vision algorithm.

44. A method according to claim 38, wherein said step of determining the length and at least one respective parameter representative of the crack position, for each identified crack, is carried out by means of a further trained machine learning algorithm,
or with the same trained machine learning algorithm configured to carry out said step of identifying one or more cracks.

45. A method according to claim 42, wherein said step of determining the length and at least one respective parameter representative of the crack position, for each identified crack, comprises:
calculating the length of a crack based on the coordinates of the respective ends;
calculating said at least one respective parameter representative of the crack position as the distance of the end of the crack closest to the edge based on the coordinates of said end and the coordinates of the edge, with respect to said reference system.

46. A method according to claim 38, wherein said step of calculating the parameter representative of the crack position comprises calculating the radial position and/or angular location of the crack on the brake disc.

47. A method according to claim 30, operating on objects in wood and/or plastic and/or fabric and/or in glassy and/or ceramic and/or cementitious and/or metal materials.

48. A method for performing a fatigue test on a mechanical component, comprising:
performing a method for identifying and characterizing surface defects according to claim 30 during the performance of the fatigue test;
proceeding with the fatigue test if all the crack evaluation criteria of a predefined set of evaluation criteria are met;
stopping the fatigue test if at least one of the evaluation criteria is not met.

49. A method for performing a fatigue test on a brake disc, comprising:
performing a method for identifying and characterizing cracks according to claim 38 during the performance of the fatigue test;
proceeding with the fatigue test if all the crack evaluation criteria of a predefined set of evaluation criteria are met;
stopping the fatigue test if at least one of the evaluation criteria is not met;
wherein said predefined evaluation criteria comprise:
the length of each crack is less than a predefined maximum length, considered no longer acceptable for the continuation of the fatigue test; and/or
the ends of all the cracks are distant from the edges of the braking surface or brake disc more than a predefined minimum distance which is no longer considered acceptable for the continuation of the fatigue test.
